(19) United States
(12) Patent Application Publication
(10) Pub. No.: US 2026/0127748 A1
(43) Pub. Date: May 7, 2026

(54) HIGH-ACCURACY NON-CAUSAL TRACKING THROUGH ITERATIVE FORWARD-BACKWARD POINT-CLOUD AGGREGATION

(71) Applicant: QUALCOMM Incorporated, San Diego, CA (US)

(72) Inventors: Madhumitha Sakthi, Dublin, CA (US); Amin Ansari, Kirkland, WA (US); Sai Madhuraj Jadhav, Foster City, CA (US)

(21) Appl. No.: 18/934,876

(22) Filed: Nov. 1, 2024

(51) Int. Cl. G06T 7/246; G01S 17/89

(52) U.S. Cl. CPC G06T 7/248; G01S 17/89; G06T 2207/30241; G06T 2207/30252

(57) ABSTRACT

A method for tracking objects of interest includes obtaining input data generated by sensors of a vehicle; generating, based on the input data, a point cloud sequence comprising a plurality of point clouds, wherein each point cloud in the point cloud sequence represents a picture of an environment surrounding the vehicle at a specific moment in time; processing the point cloud sequence in a forward direction to generate a first set of tracking identifiers (IDs) for objects detected in the point cloud sequence; processing the point cloud sequence in a backward direction to generate a second set of tracking IDs for objects detected in the point cloud sequence; combining the first set and the second set of tracking IDs to generate a combined set of tracking IDs for the objects; and tracking the objects using the point cloud sequence and the combined set of tracking IDs to generate tracking output.

### TECHNICAL FIELD

This disclosure relates to image processing.

### BACKGROUND

Among other challenges, autonomous driving systems need to accurately detect and track moving objects such as vehicles, pedestrians, and cyclists in real time. In autonomous driving, tracking may involve annotations for every frame (picture) of a sensor output, while detection can often get by with sparse annotations (e.g., once every 10 pictures). This is because tracking involves continuously updating the location of an object over time, whereas detection may only involve identifying the presence or absence of the object in a given picture. Tracking annotations may also specify the identity of each object, which may add another layer of complexity.

Object identity may be used because tracking may involve following the same object across multiple pictures and the object being tracked may be distinguished from other objects. In many contemporary autonomous driving systems, the annotations may be more complex for tracking. For example, tracking annotations may specify the bounding box, orientation, and potentially other attributes of the object, while detection annotations may only include a bounding box. In some examples, annotating a medium-sized dataset, even with experienced annotators, may take several months.

### SUMMARY

This disclosure describes techniques for object tracking. These techniques may involve tracking objects in a video sequence from the first picture in the video sequence to the last picture in the video sequence using a forward pass. During the forward pass, the disclosed techniques may assign a unique ID to each tracked object. The forward pass may provide an initial estimate of the trajectory of the object.

The disclosed techniques may also track objects in the video sequence from the last picture in the video sequence to the first picture in the video sequence using a backward pass. During the backward pass, the disclosed techniques may assign unique IDs to tracked objects in this reverse direction. The backward pass may provide a complementary perspective on the trajectory of the object.

In one example, a method for tracking objects of interest includes obtaining input data generated by one or more sensors of a vehicle; generating, based on the input data, a point cloud sequence comprising a plurality of point clouds, wherein each point cloud in the point cloud sequence represents a picture of an environment surrounding the vehicle at a specific moment in time; processing the point cloud sequence in a forward direction to generate a first set of tracking identifiers (IDs) for one or more objects detected in the point cloud sequence; processing the point cloud sequence in a backward direction to generate a second set of tracking IDs for one or more objects detected in the point cloud sequence; combining the first set of tracking IDs and the second set of tracking IDs to generate a combined set of tracking IDs for the one or more objects; and tracking the one or more objects using the point cloud sequence and the combined set of tracking IDs to generate tracking output.

In another example, a system for tracking objects of interest includes a memory for storing input data; and processing circuitry in communication with the memory. The processing circuitry is configured to obtain the input data generated by one or more sensors of a vehicle and generate, based on the input data, a point cloud sequence comprising a plurality of point clouds. Each point cloud in the point cloud sequence represents a picture of an environment surrounding the vehicle at a specific moment in time. The processing circuitry is also configured to process the point cloud sequence in a forward direction to generate a first set of tracking identifiers (IDs) for one or more objects detected in the point cloud sequence and process the point cloud sequence in a backward direction to generate a second set of tracking IDs for one or more objects detected in the point cloud sequence. The processing circuitry is further configured to combine the first set of tracking IDs and the second set of tracking IDs to generate a combined set of tracking IDs for the one or more objects and to track the one or more objects using the point cloud sequence and the combined set of tracking IDs to generate tracking output.

In yet another example, non-transitory computer-readable storage media having instructions encoded thereon, the instructions configured to cause processing circuitry to: obtain input data generated by one or more sensors of a vehicle and generate, based on the input data, a point cloud sequence comprising a plurality of point clouds. Each point cloud in the point cloud sequence represents a picture of an environment surrounding the vehicle at a specific moment in time. Additionally, the instructions are configured to cause processing circuitry to: process the point cloud sequence in a forward direction to generate a first set of tracking identifiers (IDs) for one or more objects detected in the point cloud sequence and process the point cloud sequence in a backward direction to generate a second set of tracking IDs for one or more objects detected in the point cloud sequence. Furthermore, the instructions are configured to combine the first set of tracking IDs and the second set of tracking IDs to generate a combined set of tracking IDs for the one or more objects and to track the one or more objects using the point cloud sequence and the combined set of tracking IDs to generate tracking output.

The details of one or more examples are set forth in the accompanying drawings and the description below. Other features, objects, and advantages will be apparent from the description, drawings, and claims.

### BRIEF DESCRIPTION OF DRAWINGS

FIG. 1 is a diagram of an example autonomous vehicle, in accordance with the techniques of this disclosure.

FIG. 2 is a block diagram illustrating an example system that may perform the techniques of this disclosure.

FIG. 3 is an example of pseudo-LiDAR point cloud generated by a Machine Learning (ML) system, in accordance with the techniques of this disclosure.

FIG. 4 is a block diagram illustrating implementation of object tracking through iterative forward-backward processing and point-cloud aggregation, in accordance with the techniques of this disclosure.

FIG. 5 is a flowchart illustrating an example method for tracking objects of interest, in accordance with the techniques of this disclosure.

### DETAILED DESCRIPTION

In autonomous driving applications, annotating a medium-sized dataset, even with experienced annotators, may be a time-intensive process due to the meticulous nature of the task, which may involve careful labeling of objects, attributes, or actions within each picture. The labor-intensive nature of annotation may drive up costs. Depending on the complexity of the task, the number of annotations required, and the geographic location of the annotators, costs may easily reach several million dollars. The high costs and time requirements associated with manual annotation have led to a strong industry interest in automating the annotation process. Auto annotation tools, if effective, could significantly reduce both costs and time, making it easier and more affordable to create large, annotated datasets. However, the quality of auto annotations is a major concern. While the auto annotation tools may be effective for certain tasks, these tools may struggle with complex or ambiguous cases. Therefore, traditional annotation approaches typically use a combination of manual and automated annotation to achieve the desired level of accuracy.

Furthermore, accurate auto-labeling systems may significantly reduce the time and cost associated with manually annotating large datasets for autonomous driving. Time and cost reduction may be particularly important as the volume of data for training the autonomous driving systems and/or advanced driving assistance systems (ADAS) continues to grow.

One current approach in auto-labeling may automate repetitive tasks, freeing up human annotators to focus on more complex or challenging cases. Such automation may improve overall efficiency and productivity. Auto-labeling systems may provide consistency in labeling, which may be important for training accurate and reliable models. Manual labeling may introduce variability due to human error or differences in interpretation.

LiDAR (Light Detection and Ranging) is one type of sensor used in autonomous driving applications. LiDAR may provide a rich source of data that may be used to generate annotations. LiDAR sensors may capture 3D point clouds, providing detailed information about the environment, including objects, positions of the objects, and shapes of the objects.

By leveraging LiDAR data, the amount of manual effort to create annotations may be reduced. For example, in the context of autonomous driving and computer vision, LiDAR data may be used to automatically detect and label objects such as, but not limited to, vehicles, pedestrians, and traffic signs.

When training low-cost sensor-based networks for tasks like object detection or tracking, providing annotations that are robust to partial object occlusions may be important because real-world environments often present scenarios where objects are only partially visible due to factors such as, but not limited to, other objects obstructing the view, poor lighting conditions, or sensor limitations. Annotations that account for partial occlusions may help train models to handle real-world scenarios where objects may be partially obscured. Realistic training may improve the generalization ability of the model and may prevent overfitting to specific, ideal viewing conditions. Models trained on datasets with annotations that include partial occlusions may more accurately detect and track objects even when the objects are partially obscured, leading to better performance in real-world applications.

Furthermore, in applications like autonomous driving, accurate object detection and tracking are important for safety. Models that can handle partial occlusions are less likely to miss objects, reducing the risk of accidents. To create annotations that are robust to partial occlusions, traditional annotation systems may explicitly annotate regions where objects are partially occluded. Annotation of occlusion regions may provide the model with information about the extent of the object and may help the system to determine presence of the object even when the object is not fully visible. Traditional annotation systems may also assign confidence scores to annotations based on the degree of occlusion. Occlusion confidence scores may allow the model to weigh the importance of partially occluded objects and adjust predictions of the model accordingly.

To provide high-quality annotations regardless of single-sweep LiDAR quality and varying weather conditions, the traditional annotation approaches may combine LiDAR data with other sensor modalities, such as cameras or radar, to create more comprehensive and robust annotations.

Therefore, data fusion may help mitigate the limitations of single-sweep LiDAR and may improve the accuracy of object detection and tracking. The traditional annotation systems may also employ advanced annotation approaches that may handle noisy or incomplete LiDAR data.

Advanced annotation approaches may involve using algorithms to fill in missing data or to correct errors in the point cloud. The traditional annotation system may also apply advanced data augmentation approaches to create synthetic training data that simulates different weather conditions and LiDAR quality variations. Data augmentation may help the model generalize better to real-world scenarios. For low-cost camera-based tracking solutions, generating high-quality tracking annotations may be important for training accurate models. In autonomous driving systems the objective may be to provide dense annotations that cover every picture of the video sequence. In other words, dense annotations may be important for tracking tasks where objects may move quickly or undergo significant changes in appearance.

Consistent labeling of objects across the entire dataset may also be an important aspect of high-quality tracking annotations. For example, consistent labeling may involve using a standardized labeling scheme and carefully defining object categories and attributes.

This disclosure describes two-step techniques for object tracking. These techniques may involve tracking objects in the video sequence from the first picture in the video sequence to the last picture in the video sequence using a forward pass. During the forward pass, the disclosed techniques may assign a unique ID to each tracked object. The forward pass may provide an initial estimate of the trajectory of the object. The disclosed techniques may also track objects in the video sequence from the last picture to the first one using a backward pass. During the backward pass, the disclosed techniques may assign unique IDs to tracked objects in this reverse direction. The backward pass may provide a complementary perspective on the trajectory of the object.

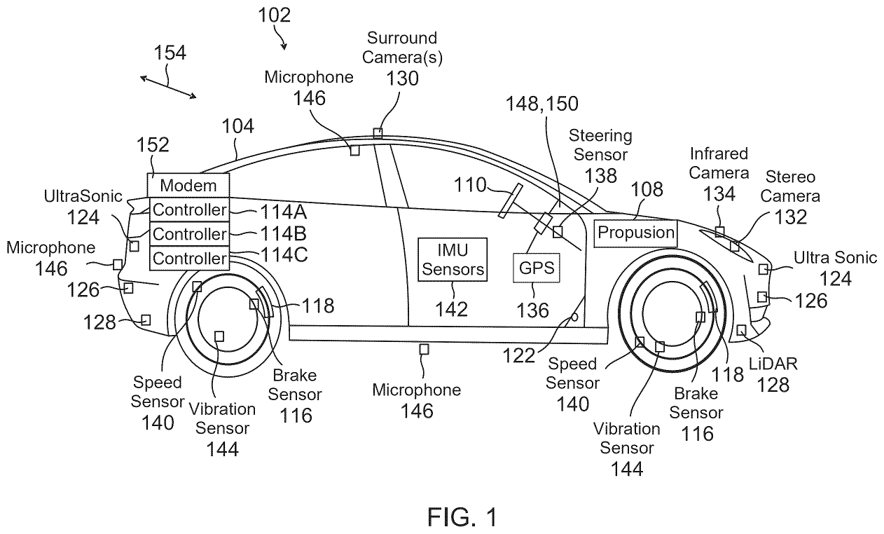

FIG. 1 shows an example vehicle 102. Vehicle 102 in the example shown may comprise a passenger vehicle such as a car or truck that can accommodate a human driver and/or human passengers. In an aspect, vehicle 102 may comprise an autonomous vehicle, semi-autonomous vehicle and/or vehicle with an ADAS system. Vehicle 102 may include a vehicle body 104 suspended on a chassis, in this example comprised of four wheels and associated axles. A propulsion system 108 such as an internal combustion engine, hybrid electric power plant, or even all-electric engine may be connected to drive some or all of the wheels via a drive train, which may include a transmission (not shown). A steering wheel 110 may be used to steer some or all of the wheels to direct vehicle 102 along a desired path when the propulsion system 108 is operating and engaged to propel the vehicle 102. Steering wheel 110 or the like may be optional for Level 5 implementations. One or more controllers 114A-114C (a controller 114) may provide autonomous capabilities in response to signals continuously provided in real-time from an array of sensors, as described more fully below.

Each controller 114 may be essentially one or more onboard computers that may be configured to perform deep learning and/or artificial intelligence functionality and output autonomous operation commands to self-drive vehicle 102 and/or assist the human vehicle driver in driving. Each vehicle may have any number of distinct controllers for functional safety and additional features. For example, controller 114A may serve as the primary computer for autonomous driving functions, controller 114B may serve as a secondary computer for functional safety functions, controller 114C may provide artificial intelligence functionality for in-camera sensors, and controller 114D (not shown) may provide infotainment functionality and provide additional redundancy for emergency situations.

Controller 114 may send command signals to operate vehicle brakes 116 via one or more braking actuators 118, operate steering mechanism via a steering actuator, and operate propulsion system 108 which also receives an accelerator/throttle actuation signal 122. Actuation may be performed by methods known to persons of ordinary skill in the art, with signals typically sent via the Controller Area Network data interface (“CAN bus”)—a network inside modern cars used to control brakes, acceleration, steering, windshield wipers, and the like. The CAN bus may be configured to have dozens of nodes, each with its own unique identifier (CAN ID). The bus may be read to find steering wheel angle, ground speed, engine RPM, button positions, and other vehicle status indicators. The functional safety level for a CAN bus interface is typically Automotive Safety Integrity Level (ASIL) B. Other protocols may be used for communicating within a vehicle, including FlexRay and Ethernet.

In an aspect, an actuation controller may be obtained with dedicated hardware and software, allowing control of throttle, brake, steering, and shifting. The hardware may provide a bridge between the vehicle's CAN bus and the controller 114, forwarding vehicle data to controller 114 including the turn signal, wheel speed, acceleration, pitch, roll, yaw, Global Positioning System (“GPS”) data, tire pressure, fuel level, sonar, brake torque, and others. Similar actuation controllers may be configured for any other make and type of vehicle, including special-purpose patrol and security cars, robo-taxis, long-haul trucks including tractor-trailer configurations, tiller trucks, agricultural vehicles, industrial vehicles, and buses.

Controller 114 may provide autonomous driving outputs in response to an array of sensor inputs including, for example: one or more ultrasonic sensors 124, one or more RADAR sensors 126, one or more LiDAR sensors 128, one or more surround cameras 130 (typically such cameras are located at various places on vehicle body 104 to image areas all around the vehicle body), one or more stereo cameras 132 (in an aspect, at least one such stereo camera may face forward to provide object recognition in the vehicle path), one or more infrared cameras 134, GPS unit 136 that provides location coordinates, a steering sensor 138 that detects the steering angle, speed sensors 140 (one for each of the wheels), an inertial sensor or inertial measurement unit (“IMU”) 142 that monitors movement of vehicle body 104 (this sensor can be for example an accelerometer(s) and/or a gyro-sensor(s) and/or a magnetic compass (cs)), tire vibration sensors 144, and microphones 146 placed around and inside the vehicle. Other sensors may be used, as is known to persons of ordinary skill in the art.

Controller 114 may also receive inputs from an instrument cluster 148 and may provide human-perceptible outputs to a human operator via human-machine interface (“HMI”) display(s) 150, an audible annunciator, a loudspeaker and/or other means. In addition to traditional information such as velocity, time, and other well-known information, HMI display 150 may provide the vehicle occupants with information regarding maps and vehicle's location, the location of other vehicles (including an occupancy grid) and even the Controller's identification of objects and status. For example, HMI display 150 may alert the passenger when the controller 114 has identified the presence of a stop sign, caution sign, or changing traffic light and is taking appropriate action, giving the vehicle occupants peace of mind that the controller 114 is functioning as intended.

In an aspect, instrument cluster 148 may include a separate controller/processor configured to perform deep learning and artificial intelligence functionality.

Vehicle 102 may collect data that is preferably used to help train and refine the neural networks used for autonomous driving. The vehicle 102 may include modem 152, preferably a system-on-a-chip that provides modulation and demodulation functionality and allows the controller 114 to communicate over the wireless network 154. Modem 152 may include an RF front-end for up-conversion from baseband to RF, and down-conversion from RF to baseband, as is known in the art. Frequency conversion may be achieved either through known direct-conversion processes (direct from baseband to RF and vice-versa) or through super-heterodyne processes, as is known in the art. Alternatively, such RF front-end functionality may be provided by a separate chip. Modem 152 preferably includes wireless functionality substantially compliant with one or more wireless protocols such as, without limitation: LTE, WCDMA, UMTS, GSM, CDMA2000, or other known and widely used wireless protocols.

Compared to sonar and RADAR sensors 126, cameras 130-134 may generate a richer set of features at a fraction of the cost. Thus, vehicle 102 may include a plurality of cameras 130-134, capturing images around the periphery of the vehicle 102. Camera type and lens selection depends on the nature and type of function. The vehicle 102 may have a mix of camera types and lenses to provide complete coverage around the vehicle 102. All camera locations on the vehicle 102 may support interfaces such as Gigabit Multimedia Serial link (GMSL) and Gigabit Ethernet.

In an aspect, a controller 114 may be configured to obtain input data generated by one or more sensors 126-134 of the vehicle 102. For example, sensors may include LiDAR sensor(s) 128, one or more cameras 130-134, RADAR sensor(s) 126. LiDAR sensors 128 emit laser beams to measure distances and to create 3D point clouds, Cameras 130-134 capture visual information of the environment. RADAR sensor(s) 126 use radio waves to detect objects and measure their distance, velocity, and direction. Next, controller 114 may generate, based on the input data, a point cloud sequence comprising a plurality of point clouds. This construction of the point cloud sequence using features extracted from the input data may create a 3D representation of the environment surrounding vehicle 102 at different moments in time. Controller 114 may then process the point cloud sequence in a forward direction to generate a first set of tracking identifiers (IDs) for one or more objects detected in the point cloud sequence. This processing step may involve grouping points in each point cloud into potential objects and describing the detected objects using features like shape, size, and motion. This step may further involve assigning labels to the detected objects (e.g., car, pedestrian, traffic sign) and assigning unique IDs to each detected object for tracking purposes. Next, controller 114 may process the point cloud sequence in a backward direction to generate a second set of tracking identifiers (IDs) for one or more objects detected in the point cloud sequence. In accordance with the techniques of the present disclosure, backward processing may improve tracking accuracy. For example, controller 114 may reduce noise and inconsistencies in the data. Controller 114 may also apply filters to ensure that object tracks are consistent over time. As noted above, controller 114 may also generate a second set of tracking IDs based on the backward processing.

In an aspect, controller 114 may also combine the first set of tracking IDs and the second set of tracking IDs to generate a combined set of tracking IDs for the one or more objects being tracked. This operation may involve identifying corresponding objects in the two sets and creating a consensus set of tracking IDs based on the matching results.

Finally, controller 114 may track one or mode objects of interest using the point cloud sequence and the combined set of tracking IDs to generate tracking output.

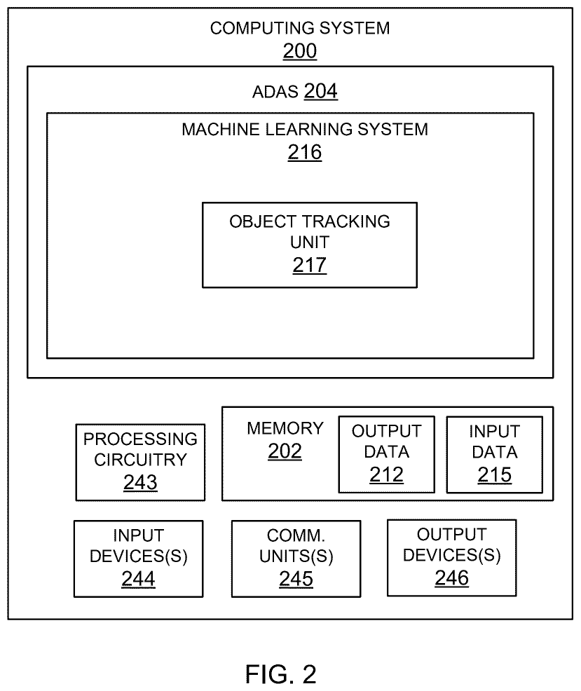

FIG. 2 is a block diagram illustrating an example computing system 200. As shown, computing system 200 comprises processing circuitry 243 and memory 202 for executing Machine Learning (ML) system 216 of ADAS 204, including object tracking unit 217, which may represent an example instance of any controller 114 described in this disclosure, such as controller 114 of FIG. 1. ADAS 204 may comprise an autonomous driving system. ML system 216 may comprise various types of neural networks, such as, but not limited to, recursive neural networks (RNNs), convolutional neural networks (CNNs), and deep neural networks (DNNs). For example, ML system 216 may also include an object detection model not shown in FIG. 2.

Computing system 200 may also be implemented as any suitable external computing system accessible by controller 114, such as one or more server computers, workstations, laptops, mainframes, cloud computing systems, High-Performance Computing (HPC) systems (i.e., supercomputing) and/or other computing systems that may be capable of performing operations and/or functions described in accordance with one or more aspects of the present disclosure. In some examples, computing system 200 may represent a cloud computing system, server farm, and/or server cluster (or portion thereof) that provides services to client devices and other devices or systems. In other examples, computing system 200 may represent or be implemented through one or more virtualized compute instances (e.g., virtual machines, containers, etc.) of a data center, cloud computing system, server farm, and/or server cluster.

The techniques described in this disclosure may be implemented, at least in part, in hardware, software, firmware or any combination thereof. For example, various aspects of the described techniques may be implemented within processing circuitry 243 of computing system 200, which may include one or more of a microprocessor, a controller, a digital signal processor (DSP), an application specific integrated circuit (ASIC), a field-programmable gate array (FPGA), or equivalent discrete or integrated logic circuitry, or other types of processing circuitry. The term “processor” or “processing circuitry” may generally refer to any of the foregoing logic circuitry, alone or in combination with other logic circuitry, or any other equivalent circuitry. A control unit comprising hardware may also perform one or more of the techniques of this disclosure.

In another example, computing system 200 comprises any suitable computing system having one or more computing devices, such as desktop computers, laptop computers, handheld devices, tablets, mobile telephones, smartphones, etc. In some examples, at least a portion of computing system 200 is distributed across a cloud computing system, a data center, or across a network, such as the Internet, another public or private communications network, for instance, broadband, cellular, Wi-Fi, ZigBee, Bluetooth® (or other personal area network-PAN), Near-Field Communication (NFC), ultrawideband, satellite, enterprise, service provider and/or other types of communication networks, for transmitting data between computing systems, servers, and computing devices.

Memory 202 may comprise one or more storage devices. One or more components of computing system 200 (e.g., processing circuitry 243, memory 202, etc.) may be interconnected to enable inter-component communications (physically, communicatively, and/or operatively). In some examples, such connectivity may be provided by a system bus, a network connection, an inter-process communication data structure, local area network, wide area network, or any other method for communicating data. Processing circuitry 243 of computing system 200 may implement functionality and/or execute instructions associated with computing system 200. Examples of processing circuitry 243 include microprocessors, application processors, display controllers, auxiliary processors, one or more sensor hubs, and any other hardware configured to function as a processor, a processing unit, or a processing device. Computing system 200 may use processing circuitry 243 to perform operations in accordance with one or more aspects of the present disclosure using software, hardware, firmware, or a mixture of hardware, software, and firmware residing in and/or executing at computing system 200. The one or more storage devices of memory 202 may be distributed among multiple devices.

Memory 202 may store information for processing during operation of computing system 200. In some examples, memory 202 comprises temporary memories, meaning that a primary purpose of the one or more storage devices of memory 202 is not long-term storage. Memory 202 may be configured for short-term storage of information as volatile memory and therefore not retain stored contents if deactivated. Examples of volatile memories include random access memories (RAM), dynamic random-access memories (DRAM), static random-access memories (SRAM), and other forms of volatile memories known in the art. Memory 202, in some examples, may also include one or more computer-readable storage media. Memory 202 may be configured to store larger amounts of information than volatile memory. Memory 202 may further be configured for long-term storage of information as non-volatile memory space and retain information after activate/off cycles. Examples of non-volatile memories include magnetic hard disks, optical discs, Flash memories, or forms of electrically programmable memories (EPROM) or electrically erasable and programmable (EEPROM) memories. Memory 202 may store program instructions and/or data associated with one or more of the modules or units described in accordance with one or more aspects of this disclosure.

Processing circuitry 243 and memory 202 may provide an operating environment or platform for one or more modules or units (e.g., object tracking unit 217), which may be implemented as software, but may in some examples include any combination of hardware, firmware, and software. Processing circuitry 243 may execute instructions and the one or more storage devices, e.g., memory 202, may store instructions and/or data of one or more modules or units. The combination of processing circuitry 243 and memory 202 may retrieve, store, and/or execute the instructions and/or data of one or more applications, modules, or software. The processing circuitry 243 and/or memory 202 may also be operably coupled to one or more other software and/or hardware components, including, but not limited to, one or more of the components illustrated in FIG. 2.

Processing circuitry 243 may execute ADAS 204 using virtualization modules, such as a virtual machine or container executing on underlying hardware. One or more of such modules may execute as one or more services of an operating system or computing platform. Aspects of ADAS 204 may execute as one or more executable programs at an application layer of a computing platform.

One or more input devices 244 of computing system 200 may generate, receive, or process input. Such input may include input from a video camera, sensor, keyboard, pointing device, voice responsive system, biometric detection/response system, button, mobile device, control pad, microphone, presence-sensitive screen, network, or any other type of device for detecting input from a human or machine.

One or more output devices 246 may generate, transmit, or process output. Examples of output are tactile, audio, visual, and/or video output. Output devices 246 may include a display, sound card, video graphics adapter card, speaker, presence-sensitive screen, one or more USB interfaces, video and/or audio output interfaces, or any other type of device capable of generating tactile, audio, video, or other output. Output devices 246 may include a display device, which may function as an output device using technologies including liquid crystal displays (LCD), quantum dot display, dot matrix displays, light emitting diode (LED) displays, organic light-emitting diode (OLED) displays, cathode ray tube (CRT) displays, e-ink, or monochrome, color, or any other type of display capable of generating tactile, audio, and/or visual output. In some examples, computing system 200 may include a presence-sensitive display that may serve as a user interface device that operates both as one or more input devices 244 and one or more output devices 246.

One or more communication units 245 of computing system 200 may communicate with devices external to computing system 200 (or among separate computing devices of computing system 200) by transmitting and/or receiving data, and may operate, in some respects, as both an input device and an output device. In some examples, communication units 245 may communicate with other devices over a network. In other examples, communication units 245 may send and/or receive radio signals on a radio network such as a cellular radio network. Examples of communication units 245 include a network interface card (e.g., such as an Ethernet card), an optical transceiver, a radio frequency transceiver, a GPS receiver, or any other type of device that can send and/or receive information. Other examples of communication units 245 may include Bluetooth®, GPS, 3G, 4G, and Wi-Fi® radios found in mobile devices as well as Universal Serial Bus (USB) controllers and the like.

In the example of FIG. 2, object tracking unit 217 may be configured to perform iterative tracking, which is a technique that involves processing a sequence of pictures multiple times, refining the tracking results with each iteration, as described herein. Object tracking unit 217 may receive input from sensors such as, but not limited to, LiDAR sensors 128 and cameras 130-134 and may generate output data 212. Input data 215 and output data 212 may contain various types of information. For example, input data 215 may include, but is not limited to, camera image data, LiDAR data, and so on. Output data 212 may include predicted object tracks, which may include bounding boxes, velocities, track IDs, and so on.

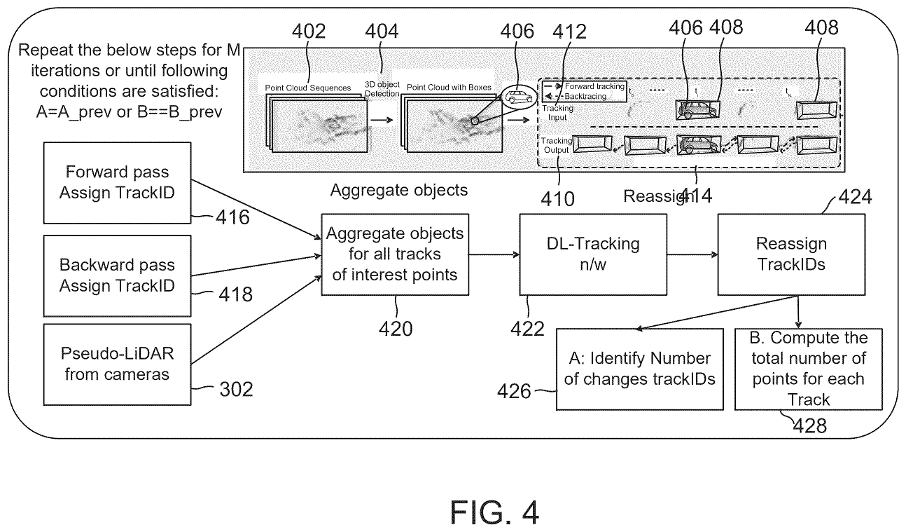

In an aspect, object tracking unit 217 may comprise a CNN. In an aspect, the object tracking unit 217 may receive a plurality of point cloud sequences. The object tracking unit 217 may be configured to perform bi-directional multi-object tracking illustrated in greater detail in FIG. 4. In an aspect, to improve object tracking in challenging environments, the object tracking unit 217 may be configured to perform iterative tracking, refining the object tracking results with each iteration. Advantageously, the disclosed techniques may detect and track features in the picture to estimate depth.

In an aspect, training data may include challenging scenarios in the dataset, such as occlusions, low-light conditions, and complex object interactions. Difficult scenarios may help the object tracking unit 217 learn to handle real-world challenges and improve performance.

LiDAR (Light Detection and Ranging) sensor 128 is a sensor that measures distance by emitting light pulses and measuring the return time for the pulses. This measurement may allow LiDAR sensor 128 to determine the range to objects in the field of view of LiDAR sensor 128. One of the advantages of LiDAR technology is the ability to capture depth information and scene geometry. By measuring the time of flight for each emitted pulse, LiDAR sensor 128 may create a 3D point cloud representing the environment.

The 3D point cloud may contain information about the distance, position, and orientation of objects within the scene. Due to ability to provide accurate depth and scene geometry information, LiDAR data may be used to train ground truth (GT) generation networks. The GT networks may be tasked with generating realistic and accurate 3D point clouds or depth maps from other sensor modalities, such as, but not limited to cameras. LiDAR data may be collected from real-world environments, capturing a variety of scenes and conditions. The LiDAR data may be annotated to provide accurate ground truth labels, such as object classifications, bounding boxes, and depth information.

While LiDAR sensor 128 is a powerful tool for capturing depth and scene geometry, there may be significant variations in the quality of LiDAR sweeps across different OEMs (Original Equipment Manufacturers). These variations may impact the accuracy and reliability of the LiDAR data collected.

The following are some factors that may influence LiDAR sweep quality. A range is the maximum distance LiDAR sensor 128 may detect objects. Longer ranges may allow for greater perception distances, but longer ranges may also come at the cost of reduced accuracy or resolution. The density of the point cloud generated by the LiDAR sensor 128 may be measured by a number of points. Higher point densities may provide more detailed information about the environment, but higher point densities may also increase computational requirements. The number of laser beams emitted by the LiDAR sensor 128 may be another factor influencing LiDAR sweep quality. More beams may improve the coverage and accuracy of the generated point cloud, but more beams may also increase the cost and complexity of the LiDAR sensor 128.

Generally, in the context of autonomous vehicles, LiDAR data may be affected by noise, such as random fluctuations in the signal, and artifacts, such as spurious points or reflections. These factors may reduce the quality of the data and make the LiDAR data more challenging to process. In addition to the quality of the LiDAR sweep itself, other factors may influence the accuracy and reliability of the LiDAR data. The calibration of the LiDAR sensor 128 may be important for ensuring that the LiDAR data is accurate and consistent. Miscalibration may lead to errors in measurements and distortions in the point cloud.

In the context of 3D object detection and tracking, environmental factors such as, but not limited to, weather conditions, lighting, and the presence of obstacles may affect the performance of the LiDAR sensor 128. For example, heavy rain or fog may reduce the range of the LiDAR sensor 128, while bright sunlight may cause glare and reflections.

While LiDAR sensor 128 is a powerful tool for capturing depth and scene geometry, LiDAR sensors 128 are not completely immune to occlusions. It should be noted that occlusions may occur when objects in the environment block the line of sight of the LiDAR sensor 128 to other objects. These occlusions may result in blind spots or incomplete information about the scene.

In dense environments, such as urban areas with tall buildings or heavy traffic, LiDAR sensor 128 may be unable to detect objects that are obscured by other objects. Trees and other vegetation may block LiDAR signals, creating blind spots in the point cloud.

Sometimes, the placement of the LiDAR sensor 128 on vehicle 102 may affect the ability of the LiDAR sensor 128 to detect objects at different heights and distances. Sensors mounted low on a vehicle may have difficulty detecting objects that are higher up, such as, but not limited to, traffic signs or overhead power lines. Tracking systems trained solely on single-sweep LiDAR data may encounter difficulties in accurately capturing the entire scene due to the potential for occlusions because single-sweep LiDAR data may only provide a snapshot of the environment at a single point in time. If objects are occluded in that snapshot, these objects may not be detected or tracked accurately. To address the aforementioned challenge, it may be necessary to combine LiDAR data with other sensor modalities, such as cameras 130-134 or RADAR sensors 126, for example.

In an example, cameras 130-134 and RADAR sensors 126 may provide complementary information that may help to fill in gaps caused by occlusions and may improve the overall accuracy of the ML system 216.

In a driving scenario, an object may temporarily go out of view due to various reasons. Other vehicles, buildings, or trees may block the view of the LiDAR sensor 128 of an object. The field of view or range of the LiDAR sensor 128 may be limited, causing objects to temporarily disappear from the perception area. The object itself may move behind or below the line of sight of the LiDAR sensor 128, leading to a temporary occlusion.

In one example, a vehicle (e.g., vehicle 102) may be driving on a road. A pedestrian may be crossing the street ahead. The camera (e.g., camera 130) of the vehicle 102 may initially detect the pedestrian. However, if the pedestrian moves behind a parked car, the view of the pedestrian of the camera 130 will be blocked. In this case, the pedestrian has temporarily gone out of view of camera 130.

Accurate detection of objects around the vehicle 102 and handling temporary occlusions in ADAS 204 may be challenging for several reasons. The ADAS 204 preferably has the ability to maintain the track of the object even when the object is temporarily out of view.

When the object reappears, ADAS 204 should be able to reacquire the reappeared object and correctly associate the reappeared object with previous track of that object. This task may be difficult if multiple objects with similar appearances are present in the scene.

In the example of the ML system 216 illustrated in FIG. 2, failing to handle temporary occlusions correctly may lead to dangerous situations. For example, if the ML system 216 fails to detect a pedestrian who has reappeared after being occluded, a collision with the pedestrian may occur.

To address the challenges of temporary occlusions, autonomous driving systems may employ various techniques, including, but not limited to, prediction models and data fusion. ML system 216 may use prediction models to estimate the future trajectory of the object based on past motion of the object. In an aspect, ML system 216 may combine information from multiple sensors, such as, but not limited to, cameras 130-134, LiDAR sensor(s) 128, and RADAR sensor 126, to improve object tracking and detection.

When an object is occluded and subsequently reappears, there may be a risk that the reappeared object may be reinitialized as a new object by the object tracking unit 217. In other words, the object tracking unit 217 may assign a new object ID to the reappearing object, even though the reappeared object may be the same object that was previously tracked. This phenomenon, known as an ID switch, may have significant implications for tracking performance. It should be noted that when an ID switch occurs, the object tracking unit 217 may lose track of the identity of the object, leading to errors in trajectory of the object and potentially causing the object to be confused with other objects. ID switches may have a detrimental impact on various tracking Key Performance Indicators (KPIs), including, but not limited to: HOTA (Hits, Overlaps, Tracking Accuracy) and MOTA (Multiple Object Tracking Accuracy).

HOTA measures the overall accuracy of a tracking system (e.g., the object tracking unit 217), considering both the number of correctly tracked objects and the accuracy of the corresponding predicted bounding boxes. ID switches may reduce HOTA by causing objects to be incorrectly tracked or by introducing errors in the bounding box predictions of the tracked objects. MOTA measures the overall accuracy of the tracking system, taking into account factors such as, but not limited to, false positives, false negatives, and ID switches. ID switches may directly contribute to MOTA degradation, as the ID switches may represent errors in the ability of the tracking system to maintain object identities. To mitigate ID switches conventional tracking system may use sophisticated algorithms to associate reappearing objects with their previous tracks based on appearance, motion, and other cues. In some cases, conventional tracking systems may maintain a memory of past tracks to help identify objects that may have been temporarily occluded.

Single backward propagation, while a valuable technique for refining tracking results, may introduce inaccuracies that may lead to false positives. The refinement process may adjust the position of bounding boxes based on the error signals from the model. However, if the initial estimates are significantly off or if the refinement process is not robust enough, the adjusted positions could still be inaccurate, leading to false positives.

The confidence scores associated with detected objects may be updated during backward propagation. If the refinement process assigns overly high confidence scores to false positives, these objects may be incorrectly classified as true detections. In LiDAR-based tracking, the composition of LiDAR points within a bounding box of the detected object may be important for determining shape and orientation of the object. Inaccuracies in the refinement process may lead to errors in the composition of LiDAR points, resulting in false positives or incorrect object classifications.

Conventional tracking systems may use data augmentation techniques to create synthetic training data that exposes the model to a wider range of variations, improving robustness of the tracking system to noise and inaccuracies. Majority of the traditional solutions described above are complex and/or computationally expensive.

In an aspect, the proposed ML system 216 may address the challenges posed by partial occlusions and low-quality LiDAR data in object tracking. By combining forward and backward tracking passes with an aggregation process, this ML system 216 may improve the accuracy and reliability of tracking results. During forward pass, object tracking unit 217 may track objects in the video sequence from the first picture to the last one using traditional DL tracking algorithms. In an aspect, object tracking unit 217 may assign unique tracklet IDs to each tracked object. With the disclosed techniques, the forward pass may provide an initial estimate of the trajectory of the object. During backward pass, ML system 216 may employ object tracking unit 217 to track objects in the video sequence from the last picture of the sequence to the first one. Once again, the object tracking unit 217 may assign unique tracklet IDs to tracked objects in this reverse direction. In an aspect, backward pass may provide a complementary perspective on the trajectory of the object. The object tracking unit 217 may combine the results from the forward and backward passes. The object tracking unit 217 may analyze the tracklet IDs from both passes to identify objects that have been consistently tracked in both directions. In an aspect, the object tracking unit 217 may aggregate the information from both passes to create a more accurate and complete representation of the trajectory of the object.

In an aspect, the iterative nature of the described above tracking process and enhanced data aggregation process described below may help address the challenges of partial occlusions and low-quality LiDAR data. In an aspect, by combining information from both forward and backward passes, the ML system 216 may help mitigate the effects of occlusions. If an object is occluded in one direction, the object may be visible in the other direction, allowing the ML system 216 to maintain track of the object.

In an aspect, the data aggregation process may help to reduce the impact of noise and artifacts in the LiDAR data.

By combining information from multiple pictures and directions, the ML system 216 may improve the accuracy and reliability of the tracking results. The iterative nature of the disclosed tracking process and the disclosed data aggregation process may help improve the accuracy of object tracking, especially in challenging scenarios. The ML system 216 may be designed to be robust to partial occlusions, which may be common in real-world driving environments.

In conventional tracking systems, dynamic objects are typically tracked in only one of the following directions. Forward direction (forward pass) is often used in real-time applications where predictions should be made based on the current and past state of the system. In turn, backward direction (backward pass) may involve tracking objects from the last picture of a sequence to the first one, reversing the direction of time. This approach may be used to refine tracking results or to identify inconsistencies in the data.

In an aspect, by combining information from both directions, ML system 216 may improve the accuracy and robustness of the tracking results.

In an aspect, backward tracking may be used to identify and correct errors that may have occurred during forward tracking. For example, if an object is mistakenly occluded or reinitialized, backward tracking may help to recover correct identity and trajectory of the object. Here, backward tracking may be used to refine the tracking results by adjusting the estimated state of the object based on subsequent behavior of the object.

Backward tracking typically contemplates access to the entire sequence of data before the data can be processed. This makes backward tracking unsuitable for real-time systems where decisions should be made based on the current and past state of the system. Backward tracking may be computationally expensive, as backward tracking contemplates processing the data in reverse order. This can make backward tracking impractical for real-time applications with limited computational resources.

While LiDAR aggregation techniques may be useful for various tasks, LiDAR aggregation techniques often remove dynamic objects from the scene because aggregation techniques typically focus on combining point clouds from multiple scans to create a more complete and accurate representation of the static environment. Dynamic objects, such as moving vehicles or pedestrians, may not be accurately represented in the aggregated point cloud due to their changing positions. To address the limitations of backward tracking and the removal of dynamic objects in LiDAR aggregation, the ML system 216 may utilize techniques combining forward and backward tracking with online aggregation that may enable real-time processing while still incorporating the benefits of both approaches.

Ghost artifacts in aggregated LiDAR point clouds may occur when dynamic objects are not motion-compensated correctly. The ghost artifacts may appear as spurious points or distorted regions in the aggregated point cloud, which may interfere with object detection and tracking.

To avoid ghost artifacts, conventional object tracking systems may implement effective motion compensation techniques for dynamic objects. Conventional object tracking systems may use a robust object tracking algorithm to accurately track the position and motion of dynamic objects. Accurate object tracking may provide the necessary information for motion compensation. Conventional object tracking systems may apply motion compensation to the LiDAR points associated with each tracked object. Motion compensation may involve shifting the points to their estimated positions in the reference frame of the aggregated point cloud.

After motion compensation, conventional object tracking systems may remove any outliers or points that are significantly different from the expected pattern. Outlier removal may help to eliminate ghost artifacts caused by errors in the tracking or motion compensation process. Conventional object tracking systems may combine LiDAR data with other sensor modalities, such as, but not limited to, cameras or radar, to improve the accuracy of object tracking and reduce the likelihood of ghost artifacts.

Iterative tracking is a technique that involves processing a sequence of pictures and/or point clouds multiple times, refining the tracking results with each iteration.

In contrast to the conventional object tracking systems, ML system 216 may employ aggregated point clouds, as described below. The disclosed techniques may be particularly useful for handling complex tracking scenarios, such as those involving occlusions, appearance changes, or rapid object motion. During the forward pass, the object tracking unit 217 may process the pictures in chronological order, from the first picture of the sequence to the last picture of the sequence. The forward pass may allow the tracking unit to establish initial object tracks and estimate trajectories of the objects.

In the backward pass, the object tracking unit 217 may process the pictures in reverse order, from the last picture to the first picture. The backward pass may help correct errors that may have occurred during the forward pass, such as, but not limited to, false positives or lost tracks.

By combining information from both forward and backward passes, the iterative techniques may provide more accurate tracking results, especially in challenging scenarios. The iterative techniques may make the object tracking unit 217 more robust to occlusions, appearance changes, and other challenges that may affect tracking performance. In an aspect, backward passes may help to identify and correct errors that may have occurred during the forward pass, such as, but not limited to, false positives or lost tracks.

In the disclosed techniques, the object tracking unit 217 may initially aggregate dynamic objects based on their assigned tracklet IDs. Tracklet IDs may be unique identifiers assigned to each tracked object, allowing the tracked objects to be distinguished from one another.

The object tracking unit 217 may group dynamic objects based on their tracklet IDs, creating initial aggregated point clouds for each object. The aggregation process may be repeated iteratively as well, with each iteration refining the aggregated point clouds based on the updated tracklet IDs.

In an aspect, the object tracking unit 217 may continue the iterative process until one or both of the following conditions are met. If no tracklet IDs change during an iteration, no change in tracklet IDs may indicate that the objects have been correctly tracked and aggregated. If the number of points in the aggregated point cloud of an object remains constant, no change in the point cloud size may suggest that the shape and extent of the object have been accurately captured.

By iteratively refining the aggregation process, the ML system 216 may improve the accuracy of the aggregated point clouds, reducing the likelihood of errors or artifacts. In an aspect, the iterative techniques may make the aggregation process more robust to noise, occlusions, and other challenges that may affect tracking accuracy.

In one example, implementation, the ML system 216 may use the following pseudo-code to implement the disclosed techniques:

| | |
|---|---|
| For i in {1,....,M} | #Iterations |
| For j in {1,...,N} | #Images |
| TrackIDsF = forward_DLT(L(j)) | #Forward DLTracking |
| | Pass |

For j in {N,... 1}

| | |
|---|---|
| TrackIDsB = forward_DLT(L(j)) | #Backward DLTracking |
| | Pass |

```
  TrackIDs = f_combine(Track IDsF, Track IDsB)
  For t in TrackIDS
    PseudoLiDARpts = PseudoLiDAR(Img, L(t), Intrnsc, Extrncs)
    Agg_LIDIMG = L(t) + PseudoLiDARpts
    L(t) = Agg_LIDARIMG
    If TrackIDs == TrackIDs_prev or f_points(AGG_LIDIMG) ==
  f_points_prev(AGG_LIDIMG)
        Break
```

In this example implementation, the ML system 216 may initially call the forward_DLT (Deep Learning Tracking) function with the current picture (e.g., image or frame) sequence as input.

The forward_DLT function may perform a forward pass, processing each picture in chronological order, from the first picture to the last picture of the sequence. The result of this function may be a set of track IDs (e.g., TrackIDsF), which may be unique identifiers assigned to the tracked objects in the provided picture sequence.

The specific implementation of the forward_DLT function may depend on the chosen tracking algorithm.

In an aspect, next, the ML system 216 may call the backward_DLT function with the same picture sequence as input. The backward_DLT function may perform a backward pass processing the pictures in reverse order, from the last picture of the sequence to the first one. The result of this function call may be a set of track IDs (e.g., TrackIDsB), which may be unique identifiers assigned to the tracked objects in the current picture sequence, processed in reverse order. The disclosed techniques may employ f_combine function configured to combine the track IDs obtained from the forward pass with the track IDs obtained from the backward pass.

The ML system 216 may utilize the f_combine function that may implement a strategy to reconcile the track IDs from both passes and may create a combined set of track IDs for the picture sequence. This reconciliation may involve comparing the track IDs, resolving conflicts, and assigning consistent identifiers to objects that are detected in both passes. In other words, the ML system 216 may first perform a forward tracking pass, followed by a backward tracking pass. The results from both passes may then be combined to create a combined set of track IDs for each frame. These techniques may help to improve tracking accuracy by considering information from both directions.

The specific implementation of the backward_DLT function and the f_combine function may depend on the chosen tracking algorithm.

Next, the ML system 216 may iterate through each track ID in the combined list. For each track ID, the ML system 216 may call the PseudoLiDAR function, configured to generate a pseudo-LiDAR point cloud, with the following arguments: the current picture, the LiDAR points associated with the current track, intrinsic camera parameters (e.g., focal length, principal point), and extrinsic camera parameters (e.g., rotation, translation)). The PseudoLiDAR function may project the picture points corresponding to the tracked object into 3D space using the provided camera parameters. This process is often referred to as “pseudo-LiDAR” because the process may create a synthetic 3D point cloud from image information.

The ML system 216 may aggregate the LiDAR points associated with the current track with the pseudo-LiDAR points (pseudo-LiDAR data) calculated in the previous step. This aggregation may create a combined point cloud that includes both the original LiDAR points and the projected picture points. The ML system 216 may iterate through each track ID, calculate pseudo-LiDAR points for the corresponding object, and aggregate these points with the original LiDAR points. The ML system 216 may effectively combine information from both the LiDAR and image data to create a more complete and accurate representation of the tracked object. The specific implementation of the PseudoLiDAR function may depend on the chosen projection method and camera calibration techniques.

As noted above, the ML system 216 may update the LiDAR points associated with the current track with the aggregated LiDAR points calculated in the previous step. This update may effectively incorporate the pseudo-LiDAR points into the overall LiDAR data for the tracked object.

The ML system 216 may check two conditions to determine whether the iterative process should terminate. In the disclosed implementation, the ML system 216 may compare the current track IDs with the track IDs from the previous iteration. If there are no changes in the track IDs, such condition may indicate that the tracking algorithm has converged, and the final track assignments may be stable. For each iteration, the ML system 216 may also compare the number of points or other properties of the aggregated LiDAR point cloud with the corresponding values from the previous iteration. If there are no changes in these properties, such condition may suggest that the aggregation process has stabilized, and the final aggregated point cloud is accurate. If either of the above conditions is met, the loop may be terminated, indicating that the iterative process has converged, and the final track assignments and aggregated point clouds can be considered as the ground truth (GT). In summary, the ML system 216 may update the aggregated LiDAR points for the current track and then may check if the tracking and aggregation process has converged. If the conditions for convergence are met, the loop may be terminated, and the final results may be considered as the ground truth. This iterative technique may help ensure that the tracking and aggregation process is accurate and stable.

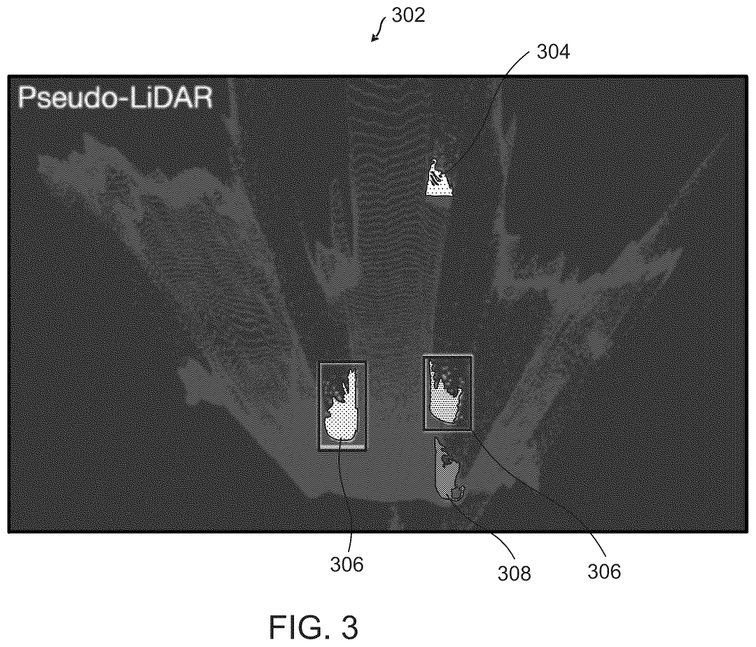

FIG. 3 is an example of pseudo-LiDAR point cloud generated by a Machine Learning (ML) system, in accordance with the techniques of this disclosure. The disclosed techniques may use greedy assignment to implement the aforementioned f_combine function.

The core idea of greedy assignment is to match pairs of elements from the two sets (e.g., forward pass track IDs and backward pass track IDs) in a way that maximizes a certain criterion. In this case, the criterion may be the similarity or compatibility between the elements.

The f_combine function implementing greedy algorithm may work as follows. The f_combine function may start with empty sets for the matched pairs.

The f_combine function may find the pair of elements from the forward and backward sets that have the highest similarity or compatibility score. The f_combine function may add this pair to the matched pairs set. The f_combine function may also remove these elements from the respective original sets. The f_combine function may repeat the second step (pair addition) until all elements are matched or a stopping criterion is met. The x % component may introduce a constraint or randomness into the matching process. In one example, this component may specify that a certain percentage (x %) of the matches should be between elements from the forward and backward sets. In one example method, random selection may be used. In this method, the f_combine function may randomly select x % of the elements from the forward and backward sets. Next, the f_combine function may match the selected elements using the greedy algorithm. Finally, the f_combine function may match the remaining elements using the greedy algorithm.

In another example implementation, the f_combine function may assign a higher weight to matches between forward and backward elements. The f_combine function may modify the greedy algorithm to prioritize the assigned matches based on the weights.

In addition to the LiDAR data, the ML system 216 may infer depth from camera pictures as well. While LiDAR sensor(s) 128 directly measure(s) depth by emitting and receiving laser pulses, cameras 130-134 capture the environment as 2D images (pictures). To infer depth from camera pictures, ML system 216 may leverage additional information or techniques.

The ML system 216 may use two surround cameras 130 placed a certain distance apart (similar to human eyes). By comparing the pictures from both cameras, the ML system 216 may identify corresponding points and may use triangulation to calculate depth. In one implementation, the ML system 216 may optimize camera poses and 3D point positions to minimize reprojection errors. In an aspect, the ML system 216 may generate a dense point cloud representing the scene.

In yet another example, the ML system 216 may estimate depth using information within a single picture. The ML system 216 may analyze picture edges and gradients to infer depth. Advantageously, the disclosed techniques may detect and track features in the picture to estimate depth. In an aspect, the ML system 216 may train deep neural networks on large datasets to predict depth directly from pictures.

In an example implementation, once depth is estimated from the camera pictures, the ML system 216 may generate a pseudo-LiDAR point cloud 302 (referred to hereinafter as pseudo-LiDAR 302). Furthermore, for each pixel in the picture, the ML system 216 may assign the estimated depth value.

In an aspect, the ML system 216 may convert the depth picture into a point cloud by projecting each pixel into 3D space using the intrinsic parameters of the camera and the estimated depth. The ML system 216 may optionally apply filtering and denoising techniques to clean up the point cloud and remove outliers. Cameras 130-134 are generally less expensive than LiDAR sensors 128. Cameras 130-134 may be integrated into existing ADAS 204 more easily. The ML system 216 may use pseudo-LiDAR 302 in various applications and environments.

The term “semantic information” refers to the meaning or interpretation of objects and scenes. By incorporating semantic information into pseudo-LiDAR 302, the ML system 216 may enrich the point cloud data with additional context.

In an aspect, the ML system 216 may identify and track objects in the camera pictures, assigning semantic labels to each object (e.g., car, pedestrian, road, building). The ML system 216 may employ a semantic segmentation technique to segment the image into regions corresponding to different semantic classes (e.g., sky, road, vegetation). The ML system 216 may combine the semantic information from the images with the 3D point cloud from the LiDAR data. The ML system 216 may perform this combination by associating semantic labels with the corresponding points in the point cloud.

Once semantic information is integrated into the pseudo-LiDAR 302, the ML system 216 may use the semantic information to paint the point cloud with colors 304-308 from the pictures. In the context of 3D point cloud, for each point in the point cloud, the ML system 216 may find the corresponding pixel in the picture. The ML system 216 may assign the color of the pixel to the point in the point cloud. If semantic information is available, the ML system 216 may assign colors 304-308 based on the semantic labels of the points, as shown in FIG. 3.

This technique of incorporating semantic information into the point cloud may provide a deeper understanding of the scene, allowing for more intelligent applications. Colored point clouds, such as pseudo-LiDAR 302, may be more visually appealing and easier to interpret. Combining LiDAR and camera data may enable a more comprehensive representation of the environment surrounding vehicle 102. It should be noted that in addition to autonomous driving, semantic-enhanced pseudo-LiDAR 302 may be used in other applications, such as, but not limited to robotics, and augmented reality.

In the context of object tracking, a mesh may be a 3D model constructed from a set of interconnected points (vertices) and lines (edges) that form triangles or polygons. This mesh may provide a simplified representation of the scene, allowing for easier analysis and manipulation.

LiDAR aggregation may involve combining multiple LiDAR scans into a single, denser point cloud. LiDAR aggregation may be used to improve the overall quality and resolution of the 3D representation. In an aspect, the mesh generated from the scene may play an important role in determining the maximum achievable quality with LiDAR aggregation for several reasons. Once the density of the LiDAR points reaches a certain threshold, further aggregation may not significantly improve the quality of the mesh because the resolution of the mesh is primarily determined by the spatial distribution of the points, not just their sheer number. A well-constructed mesh may help reduce noise and artifacts in the LiDAR data. In one implementation, by fitting a smooth surface to the points, the mesh may filter out outliers and inconsistencies. A high-quality mesh may preserve important features of the scene, such as, but not limited to, edges, corners, and planes. Feature preservation may be important for accurate object detection and recognition.

Generally, a well-structured mesh may reduce the computational cost of subsequent processing tasks, such as, but not limited to, point cloud registration or 3D reconstruction. In the context of object tracking, by analyzing the mesh, the ML system 216 may identify the point density at which further aggregation starts to yield diminishing returns. Determining desirable density may help the ML system 216 avoid unnecessary computational overhead and improve the LiDAR acquisition process.

The mesh may reveal areas in the scene where the LiDAR data is sparse or incomplete. This information about data gaps may be used by the ML system 216 to guide additional scanning or data acquisition to improve the overall coverage.

FIG. 4 is a block diagram illustrating implementation of object tracking through iterative forward-backward processing and point-cloud aggregation, in accordance with the techniques of this disclosure. For instance, the ML system 216 may use a point cloud sequence 402, which may be a series of point clouds captured over time.

In other words, each point cloud may represent a picture (snapshot) of the 3D environment at a specific moment, containing information about the position and intensity of individual points. The point cloud sequence 402 may be generated by LiDAR sensors 128, which emit laser beams and measure the time it takes for the beams to return. 3D object detection 404 may involve identifying and localizing objects in a 3D scene. In the context of point cloud sequences 402, 3D object detection 404 may mean identifying objects 406 like vehicles, pedestrians, or buildings within the captured LiDAR data. Once objects 406 are detected, the objects may be represented by bounding boxes 408. As an example, bounding box 408 may be a 3D cuboid that tightly encloses the object 406. The bounding boxes 408 may provide essential information, such as, but not limited to the position, size, and orientation of the object 406. The ML system 216 may remove outliers or spurious points that may interfere with object detection.

In essence, the ML system 216 may extract relevant features from the point clouds, such as, but not limited to, curvature, intensity, or spatial relationships. The ML system 216 may analyze the point cloud sequence 402 to estimate the motion of objects over time. Motion estimation may help in tracking objects and improving detection accuracy.

In an aspect, the ML system 216 may consider the temporal context of the point clouds to better understand the scene dynamics and identify objects that may be partially occluded or moving quickly. Similar to object detection in 2D images, the ML system 216 may adapt Region Proposal Networks (RPNs) to generate 3D proposals (potential object regions) within the point cloud sequence 402. The ML system 216 may group points based on spatial proximity and feature similarity to identify potential objects 406. For feature extraction and classification, the ML system 216 may use deep learning architectures like PointNet to extract features from the points within each proposal.

For example, the ML system 216 may classify each proposal as object 406 or background using a classifier trained on labeled data.

If multiple bounding boxes 408 overlap, the ML system 216 may select the bounding box 408 with the highest confidence score and may suppress the other bounding boxes.

As yet another alternative technique, the ML system 216 may refine the bounding box parameters to better fit the detected object.

The output 410 of the aforementioned process may include a list of detected objects (e.g., object 406), each represented by a bounding box (e.g., bounding box 408) and a corresponding class label.

Tracking input 412 may include a sequence of pictures or sequence of point clouds 402, each representing a snapshot of a scene at a particular time. In this case, the pictures may be captured from various sources, such as cameras 130-134, LiDAR sensors 128, or RADAR sensor 126. Each picture may contain information about the objects 406 and their positions within the scene.

Bidirectional multi-object tracking is a technique that may track multiple objects across a sequence of pictures and/or point cloud sequence 402, iterating through each sequence in both forward and backward directions.

Bidirectional multi-object tracking 414 may be more robust than unidirectional tracking, as this technique may handle situations where objects 406 may disappear from view and reappear later. ML system 216 may extract relevant features from each object 406 in the current picture and previous pictures, such as appearance, position, and motion information. The ML system 216 may calculate the similarity between objects 406 in different pictures based on their extracted features. The ML system 216 may assign objects in the current picture to their corresponding objects in previous pictures based on the calculated similarities. The ML system 216 may use a motion model to predict the expected position of each object 406 in the current picture based on previous state of the object 406. The ML system 216 may apply a state estimation filter to combine the predicted state with the measured state from the current picture to obtain a more accurate estimate. The ML system 216 may identify objects 406 that may be occluded by others or partially out of view.

In accordance with the techniques of the present disclosure, the object tracking unit 217 may create new tracks for newly detected objects 406. The object tracking unit 217 may update existing tracks with the estimated state of the corresponding objects 406. The object tracking unit 217 may terminate tracks for objects 406 that have been lost or are no longer relevant. The tracking output 410 may consist of a set of tracks, each representing the trajectory of an object over time. Each track may include information such as, but not limited to the identity of the object 406, estimated state (position, velocity, etc.), and temporal extent.

The tracking output 410 may be used by ADAS 204 for various tasks, including, but not limited to, detecting and tracking other vehicles, pedestrians, and obstacles.

In one non-limiting example, in the disclosed system, the forward pass 416 may involve the process of assigning unique track IDs to detected objects in a sequence of pictures and/or sequence of point clouds 402. The forward pass 416 may involve identifying objects 406 in each picture using suitable object detection algorithms.

The forward pass 416 may further involve matching detected objects 406 in the current picture with existing tracks or creating new tracks based on their appearance and motion characteristics. In an aspect, the object tracking unit 217 may be configured to update the state of existing tracks based on the detected objects 406. In one example, the object tracking unit 217 may use features like color, texture, or shape to match objects across pictures. The object tracking unit 217 may consider the velocity and direction of the object 406 to predict a future location of the object 406. In an aspect, the object tracking unit 217 may employ techniques like Hungarian algorithm or nearest neighbor matching to find the best correspondence between detected objects and existing tracks. The backward pass 418 may be a complementary process that may involve re-examining the track assignments made in the forward pass 416. In an aspect, the backward pass 418 may identify and correct any incorrect track assignments that may have occurred in the forward pass 416. The object tracking unit 217 may refine the track trajectories based on the additional information provided by the backward pass 418. In an aspect, the object tracking unit 217 may ensure that the track assignments are consistent with the overall object motion and appearance. In an aspect, the object tracking unit 217 may account for cases where objects 406 may be occluded or temporarily disappear from view. The object tracking unit 217 may combine tracks that represent the same object but may have been split due to tracking errors.

As noted above, pseudo-LiDAR refers to a technique for generating depth information from camera images, similar to what a LiDAR sensor would produce. The pseudo-LiDAR technique may be achieved using various methods, such as, but not limited to, stereo vision and monocular depth estimation. In this case, for the stereo vision, the ML system 216 may use two cameras 130 to create a 3D representation of the scene based on the parallax between the pictures. The monocular depth estimation may involve estimating depth from a single image using techniques like, but not limited to, edge detection, optical flow, or deep learning. In an aspect, once depth information is obtained, this information may be used to create a point cloud, which is a collection of 3D points representing the scene. This pseudo-LiDAR data may then be integrated with other sensor data, such as RADAR or real LiDAR, to improve the overall perception and tracking capabilities of the ML system 216.

As shown in FIG. 4, the ML system 216 may aggregate objects of interest points for all tracks 420 based on the data received from the forward pass 416, backward pass 418 and pseudo-LiDAR 302. In this case, the ML systems 216 may aggregate the objects 406 into clusters of interest points (IP) that are likely to correspond to the same object in the scene. In some examples, the ML system 216 may aggregated objects of IP points for all tracks 420 into a mesh, as described above. In an aspect, the clusters may be generated from the raw sensor data (e.g., LiDAR scans, camera images) using various techniques described above. The forward pass 416 refers to processing the input data (e.g., LiDAR scans) in a sequential manner, from the first picture to the last. During this pass, interest points may be extracted and grouped into potential clusters based on their spatial proximity and temporal consistency. The backward pass 418 may be a complementary process that starts from the last picture back to the first. The backward pass 418 may help to refine the clusters and identify potential false positives by considering the future evolution of the scene. As noted above, pseudo-LiDAR technique is a technique that may create a synthetic LiDAR-like point cloud (e.g., pseudo-LiDAR 302) from camera images and depth information. The pseudo-LiDAR 302 may be used to augment the available sensor data and improve the accuracy of cluster generation. Next, the ML system 216 may employ Deep Learning (DL)-based tracking algorithms 422. The DL-based tracking algorithms 422 may use deep neural networks to learn and predict the motion and appearance of objects 406 in the scene. The object tracking unit 217 that implements these algorithms may take the generated clusters of IPs as input and may output 410 predicted object tracks, which may include bounding boxes, velocities, and track IDs. Next, the ML system 216 may reassign TrackIDs 424. Track ID reassignment is the process of associating newly detected objects with existing tracks or creating new tracks if necessary. The ML system 216 may perform track ID reassignment based on the spatial and temporal proximity of the objects 406 and their appearance features. Various algorithms may be used for track ID reassignment, such as data association techniques (e.g., Hungarian algorithm, nearest neighbor) and/or graph-based methods. In summary, the ML system 216 may collect raw sensor data (e.g., LiDAR scans, camera images, etc.). The ML system 216 may extract interest points and may group them into clusters using data received from forward pass 416, backward pass 418, and potentially pseudo-LiDAR 302. Finally, the ML system 216 may use the object tracking unit 217 implementing DL-based tracking algorithms 422 to predict object tracks from the clusters of IPs and to re-assign tracking IDs 424.

In an aspect, the track reassignment process may involve identifying number of changes in track IDs 426 and/or computing the total number of points for each track 428. The ML system 216 may iterate through steps 420-424 shown in FIG. 4 for a predefined number of iterations (e.g., M iterations) or until one of the following conditions is satisfied: 1) number of changes of TrackIDs is equal to the number of changes of TrackIDs in the previous iteration; 2) the total number of points for each track is equal to the total number of points for each track in the previous iteration.

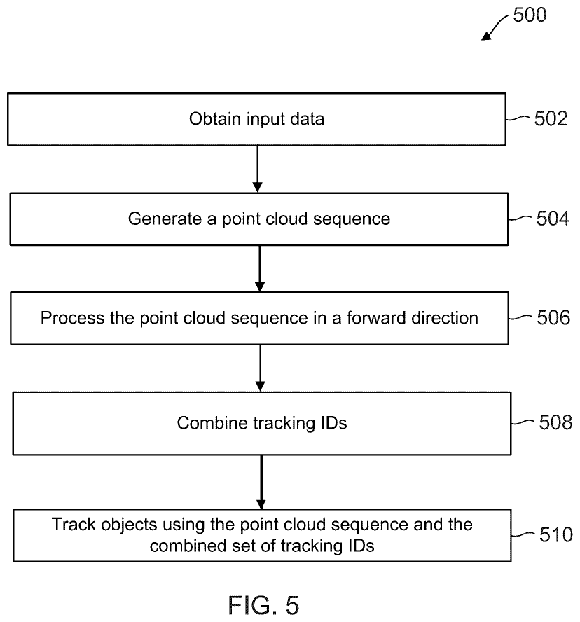

FIG. 5 is a flowchart illustrating an example method for tracking objects of interest, in accordance with the techniques of this disclosure. Although described with respect to computing system 200 (FIG. 2), it should be understood that other devices may be configured to perform a method similar to that of FIG. 5.

In this example, ML system 216 may initially obtain input data 215 from one or more sensor of vehicle 102 (502). For example, input data 215 may include, but is not limited to, LiDAR data, camera image data, and so on. The ML system 216 may generate, based on the input data, a point cloud sequence comprising a plurality of point clouds (504). In the example of FIG. 4, each point cloud in the point cloud sequence 402 may represent a picture of an environment surrounding vehicle 102 at a specific moment in time. Next, the ML system 216 may process the point cloud sequence in a forward direction to generate a first set of tracking identifiers (IDs) for one or more objects detected in the point cloud sequence (506). In an aspect, the forward pass may provide an initial estimate of the trajectory of each tracked object. The ML system 216 may process the point cloud sequence in a backward direction to generate a second set of tracking IDs for one or more objects detected in the point cloud sequence (508). The backward pass may provide a complementary perspective on the trajectory of each detected object. Next, the ML system 216 may combine the first set of tracking IDs and the second set of tracking IDs to generate a combined set of tracking IDs for the one or more objects (510). Finally, the ML system 216 may track the one or mode objects using the point cloud sequence and the combined set of tracking IDs to generate tracking output (512). Advantageously, the ML system 216 may employ iterative tracking technique that involves processing a sequence of point clouds multiple times, refining the tracking results with each iteration.

The following numbered clauses illustrate one or more aspects of the devices and techniques described in this disclosure.

Clause 1. A method for tracking objects of interest includes obtaining input data generated by one or more sensors of a vehicle; generating, based on the input data, a point cloud sequence comprising a plurality of point clouds, wherein each point cloud in the point cloud sequence represents a picture of an environment surrounding the vehicle at a specific moment in time; processing the point cloud sequence in a forward direction to generate a first set of tracking identifiers (IDs) for one or more objects detected in the point cloud sequence; processing the point cloud sequence in a backward direction to generate a second set of tracking IDs for one or more objects detected in the point cloud sequence; combining the first set of tracking IDs and the second set of tracking IDs to generate a combined set of tracking IDs for the one or more objects; and tracking the one or mode objects using the point cloud sequence and the combined set of tracking IDs to generate tracking output.

Clause 2. The method of clause 1, further comprising: iteratively aggregating a plurality of LiDAR points to the point cloud sequence until a termination condition is met.

Clause 3. The method of clause 2, wherein the termination condition comprises no changes in the combined set of tracking IDs between two consecutive iterations.

Clause 4. The method of clause 2, wherein iteratively aggregating the plurality of LiDAR points further comprises: generating pseudo-LiDAR data for one or more tracking IDs in the combined set based on the input data generated by one or more cameras of the vehicle.

Clause 5. The method of clause 4, further comprising: incorporating the pseudo-LiDAR data into the aggregated plurality of LiDAR data points for an object associated with a corresponding tracking ID.

Clause 6. The method of clause 5, wherein the termination condition comprises no changes in the aggregated plurality of LiDAR data points between two consecutive iterations.

Clause 7. The method of any of clauses 1-6, wherein combining the first set of tracking IDs and the second set of tracking IDs comprises: assigning consistent track IDs to objects detected in both the processing the point cloud sequence in the forward direction and the processing the point cloud sequence in the backward direction.

Clause 8. The method of clause 4, further comprising: refining the tracking output based on the aggregated plurality of LiDAR points.

Clause 9. The method of any of clauses 1-8, further comprising operating an Advanced Driver Assistance System (ADAS) based on the tracking output.

Clause 10. A system for tracking objects of interest, the system comprising: a memory for storing input data; and processing circuitry in communication with the memory, wherein the processing circuitry is configured to: obtain the input data generated by one or more sensors of a vehicle; generate, based on the input data, a point cloud sequence comprising a plurality of point clouds, wherein each point cloud in the point cloud sequence represents a picture of an environment surrounding the vehicle at a specific moment in time; process the point cloud sequence in a forward direction to generate a first set of tracking identifiers (IDs) for one or more objects detected in the point cloud sequence; process the point cloud sequence in a backward direction to generate a second set of tracking IDs for one or more objects detected in the point cloud sequence; combine the first set of tracking IDs and the second set of tracking IDs to generate a combined set of tracking IDs for the one or more objects; and track the one or more objects using the point cloud sequence and the combined set of tracking IDs to generate tracking output.

Clause 11. The system of clause 10, wherein the processing circuitry is further configured to: iteratively aggregate a plurality of LiDAR points to the point cloud sequence until a termination condition is met.

Clause 12. The system of clause 11, wherein the termination condition comprises no changes in the combined set of tracking IDs between two consecutive iterations.

Clause 13. The system of clause 11, wherein the processing circuitry configured to iteratively aggregate the plurality of LiDAR points is further configured to: generate pseudo-LiDAR data for one or more tracking IDs in the combined set based on the input data generated by one or more cameras of the vehicle.

Clause 14. The system of clause 13, wherein the processing circuitry is further configured to: incorporate the pseudo-LiDAR data into the aggregated plurality of LiDAR data points for an object associated with a corresponding tracking ID.

Clause 15. The system of clause 14, wherein the termination condition comprises no changes in the aggregated plurality of LiDAR data points between two consecutive iterations.

Clause 16. The system of any of clauses 10-15, wherein the processing circuitry configured to combine the first set of tracking IDs and the second set of tracking IDs is further configured to: assign consistent track IDs to objects detected in both the processing the point cloud sequence in the forward direction and the processing the point cloud sequence in the backward direction.

Clause 17. The system of clause 13, wherein the processing circuitry is further configured to: refine the tracking output based on the aggregated plurality of LiDAR points.

Clause 18. The system of any of clauses 10-17, wherein the processing circuitry is further configured to: operate an Advanced Driver Assistance System (ADAS) based on the generated tracking output.

Clause 19. Non-transitory computer-readable storage media having instructions encoded thereon, the instructions configured to cause processing circuitry to: obtain input data generated by one or more sensors of a vehicle; generate, based on the input data, a point cloud sequence comprising a plurality of point clouds, wherein each point cloud in the point cloud sequence represents a picture of an environment surrounding the vehicle at a specific moment in time; process the point cloud sequence in a forward direction to generate a first set of tracking identifiers (IDs) for one or more objects detected in the point cloud sequence; process the point cloud sequence in a backward direction to generate a second set of tracking IDs for one or more objects detected in the point cloud sequence; combine the first set of tracking IDs and the second set of tracking IDs to generate a combined set of tracking IDs for the one or more objects; and track the one or more objects using the point cloud sequence and the combined set of tracking IDs to generate tracking output.

Clause 20. The non-transitory computer-readable storage media of clause 19, wherein the instructions are further configured to cause the processing circuitry to: iteratively aggregate a plurality of LiDAR points to the point cloud sequence until a termination condition is met.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media may include one or more of RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more DSPs, general purpose microprocessors, ASICs, FPGAs, or other equivalent integrated or discrete logic circuitry. Accordingly, the terms “processor” and “processing circuitry,” as used herein may refer to any of the foregoing structures or any other structure suitable for implementation of the techniques described herein. In addition, in some aspects, the functionality described herein may be provided within dedicated hardware and/or software modules or units configured for encoding and decoding or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method for tracking objects of interest comprising:
obtaining input data generated by one or more sensors of a vehicle;
generating, based on the input data, a point cloud sequence comprising a plurality of point clouds, wherein each point cloud in the point cloud sequence represents a picture of an environment surrounding the vehicle at a specific moment in time;
processing the point cloud sequence in a forward direction to generate a first set of tracking identifiers (IDs) for one or more objects detected in the point cloud sequence;
processing the point cloud sequence in a backward direction to generate a second set of tracking IDs for one or more objects detected in the point cloud sequence;
combining the first set of tracking IDs and the second set of tracking IDs to generate a combined set of tracking IDs for the one or more objects; and
tracking the one or more objects using the point cloud sequence and the combined set of tracking IDs to generate tracking output.

2. The method of claim 1, further comprising:
iteratively aggregating a plurality of LiDAR points to the point cloud sequence until a termination condition is met.

3. The method of claim 2, wherein the termination condition comprises no changes in the combined set of tracking IDs between two consecutive iterations.

4. The method of claim 2, wherein iteratively aggregating the plurality of LiDAR points further comprises:
generating pseudo-LiDAR data for one or more tracking IDs in the combined set based on the input data generated by one or more cameras of the vehicle.

5. The method of claim 4, further comprising:
incorporating the pseudo-LiDAR data into the aggregated plurality of LiDAR data points for an object associated with a corresponding tracking ID.

6. The method of claim 5, wherein the termination condition comprises no changes in the aggregated plurality of LiDAR data points between two consecutive iterations.

7. The method of claim 1, wherein combining the first set of tracking IDs and the second set of tracking IDs comprises:
assigning consistent track IDs to objects detected in both the processing the point cloud sequence in the forward direction and the processing the point cloud sequence in the backward direction.

8. The method of claim 4, further comprising:
refining the tracking output based on the aggregated plurality of LiDAR points.

9. The method of claim 1, further comprising operating an Advanced Driver Assistance System (ADAS) based on the tracking output.

10. A system for tracking objects of interest, the system comprising:
a memory for storing input data; and
processing circuitry in communication with the memory, wherein the processing circuitry is configured to:
obtain the input data generated by one or more sensors of a vehicle;
generate, based on the input data, a point cloud sequence comprising a plurality of point clouds, wherein each point cloud in the point cloud sequence represents a picture of an environment surrounding the vehicle at a specific moment in time;
process the point cloud sequence in a forward direction to generate a first set of tracking identifiers (IDs) for one or more objects detected in the point cloud sequence;
process the point cloud sequence in a backward direction to generate a second set of tracking IDs for one or more objects detected in the point cloud sequence;
combine the first set of tracking IDs and the second set of tracking IDs to generate a combined set of tracking IDs for the one or more objects; and
track the one or more objects using the point cloud sequence and the combined set of tracking IDs to generate tracking output.

11. The system of claim 10, wherein the processing circuitry is further configured to:
iteratively aggregate a plurality of LiDAR points to the point cloud sequence until a termination condition is met.

12. The system of claim 11, wherein the termination condition comprises no changes in the combined set of tracking IDs between two consecutive iterations.

13. The system of claim 11, wherein the processing circuitry configured to iteratively aggregate the plurality of LiDAR points is further configured to:
generate pseudo-LiDAR data for one or more tracking IDs in the combined set based on the input data generated by one or more cameras of the vehicle.

14. The system of claim 13, wherein the processing circuitry is further configured to:
incorporate the pseudo-LiDAR data into the aggregated plurality of LiDAR data points for an object associated with a corresponding tracking ID.

15. The system of claim 14, wherein the termination condition comprises no changes in the aggregated plurality of LiDAR data points between two consecutive iterations.

16. The system of claim 10, wherein the processing circuitry configured to combine the first set of tracking IDs and the second set of tracking IDs is further configured to:
assign consistent track IDs to objects detected in both the processing the point cloud sequence in the forward direction and the processing the point cloud sequence in the backward direction.

17. The system of claim 13, wherein the processing circuitry is further configured to:
refine the tracking output based on the aggregated plurality of LiDAR points.

18. The system of claim 10, wherein the processing circuitry is further configured to:
operate an Advanced Driver Assistance System (ADAS) based on the generated tracking output.

19. Non-transitory computer-readable storage media having instructions encoded thereon, the instructions configured to cause processing circuitry to:
obtain input data generated by one or more sensors of a vehicle;
generate, based on the input data, a point cloud sequence comprising a plurality of point clouds, wherein each point cloud in the point cloud sequence represents a picture of an environment surrounding the vehicle at a specific moment in time;
process the point cloud sequence in a forward direction to generate a first set of tracking identifiers (IDs) for one or more objects detected in the point cloud sequence;
process the point cloud sequence in a backward direction to generate a second set of tracking IDs for one or more objects detected in the point cloud sequence;
combine the first set of tracking IDs and the second set of tracking IDs to generate a combined set of tracking IDs for the one or more objects; and
track the one or more objects using the point cloud sequence and the combined set of tracking IDs to generate tracking output.

20. The non-transitory computer-readable storage media of claim 19, wherein the instructions are further configured to cause the processing circuitry to:
iteratively aggregate a plurality of LiDAR points to the point cloud sequence until a termination condition is met.
